(19) United States
(12) Patent Application Publication
(10) Pub. No.: US 2008/0252830 A1
(43) Pub. Date: Oct. 16, 2008

(54) Liquid crystal display device

(76) Inventors: Dong-Soo Son, Suwon-si (KR); Mikiya Itakura, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/081,056

(22) Filed: Apr. 10, 2008

(30) Foreign Application Priority Data
Apr. 11, 2007 (KR) 10-2007-0035632

(51) Int. Cl. G02F 1/1335

(52) U.S. Cl. 349/106

(57) ABSTRACT

A LCD device includes a first substrate having a plurality of first electrodes, a second substrate having a plurality of second electrodes, the second electrodes being perpendicular to the first electrodes to define sub-pixels at intersection regions between the first and second electrodes, a reflective film between the first and second substrates, each reflective portion being positioned in a respective sub-pixel to define a reflective region and a transmission region in the respective sub-pixel, a plurality of color filters between the first and second substrates, a black matrix between the color filters, and a plurality of patterned spacers between the first and second substrates, each patterned spacer overlapping the reflective portion of the reflective film in the respective sub-pixel.

### BACKGROUND OF THE INVENTION

1. Field of the Invention

Embodiments of the present invention relate to a liquid crystal display (LCD) device. More particularly, embodiments of the present invention relate to a LCD device with patterned spacers.

2. Description of the Related Art

A LCD device may refer to a flat panel display device displaying images using physical and optical properties of liquid crystals. The LCD may exhibit low power consumption, as well as lightweight, thinness, and various sizes, as compared to other display devices. Accordingly, a LCD may be widely applied in various fields.

More specifically, the conventional LCD device may include liquid crystals between two substrates, so application of voltage to the LCD may modify polarization of light passing through the liquid crystals. Such conventional LCD devices may be classified into twist nematic LCDs (TN-LCDs) and super twist nematic LCDs (STN-LCDs) with respect to a twist degree of liquid crystal molecules of the liquid crystals between the substrates. For example, the conventional STN-LCD may have a twist angle of about 240 degrees to about 270 degrees, and may be of a passive matrix type, i.e., each pixel may be driven by two electrode terminals, or of an active matrix type, i.e., being driven independently via a switching transistor and a diode.

The conventional LCD devices may be also classified into transmission type LCDs, i.e., devices that transmit light from a backlight source toward a screen to display images, reflective type LCDs, i.e., devices that employ external light to display images, and transflective type LCDs, i.e., devices employing both a backlight source and external light as light sources to form images. Use of a backlight as a light source may increase brightness and power consumption, while use of external light as a light source may reduce both brightness and power consumption.

The conventional LCD device may be formed by sealing the two substrates with the liquid crystals therebetween. Spacers may be placed between the two sealed substrates in order to maintain a cell gap therebetween. The conventional spacers may have a spherical shape, and may be scattered by, e.g., a nozzle jet.

However, scattering of the spherically-shaped spacers may cause non-uniform distribution thereof on the substrate and trigger a non-uniform cell gap in the LCD device which, in turn, may cause light leakage and stain-like appearance phenomenon in one or more areas of the LCD panel. Further, scattering of the spherically-shaped spacers may trigger an overlap between the spacers and pixels of the LCD device, so aperture ratio and transmittance of the LCD device may be decreased.

### SUMMARY OF THE INVENTION

Embodiments of the present invention are therefore directed to a LCD device, which substantially overcomes one or more of the disadvantages of the related art.

It is therefore a feature of an embodiment of the present invention to provide a LCD exhibiting reduced light leakage and improved transmittance.

At least one of the above and other features and advantages of the present invention may be realized by providing a LCD device, including a first substrate having a plurality of first electrodes, a second substrate facing the first substrate and having a plurality of second electrodes, the second electrodes being perpendicular to the first electrodes to define sub-pixels at intersection regions between the first and second electrodes, a reflective film between the first and second substrates, the reflective film including a plurality of reflective portions, each reflective portion being positioned in a respective sub-pixel to define a reflective region and a transmission region in the respective sub-pixel, a plurality of color filters between the first and second substrates, each color filter being in a respective sub-pixel and overlapping the reflective region and the transmission region of the respective sub-pixel, a black matrix between the color filters, a planarization layer between the first and second substrates, a plurality of patterned spacers in respective sub-pixels between the first and second substrates, each patterned spacer overlapping the reflective portion of the reflective film in the respective sub-pixel, and liquid crystals between the first and second substrates.

The LCD device may further include first and second alignment layers on inner surfaces of the first and second substrates, respectively. The color filters may include red, green, and blue color filters. Three sub-pixels including red, green, and blue color filters may define a single unit pixel. The patterned spacers may be in sub-pixels including green color filters and/or in sub-pixels including blue color filters. The color filters may have a bent vertical cross-section.

The patterned spacers may be on the planarization layer, the planarization layer being between the patterned spacers and the color filters. The patterned spacers may have a column shape. Each of the patterned spacers may entirely overlap the reflective portions of the reflective film in the respective sub-pixel. A diameter of the patterned spacer may be narrower than the reflective portion of the reflective film in the respective sub-pixel. A reflective portion in each sub-pixel may be on an upper surface of the sub-pixel, the upper surface being adjacent to the second substrate. A portion of a respective color filter may be between the reflective portion and a respective patterned spacer. The LCD device may be a transflective type LCD device of a passive matrix scheme. The black matrix may be on the second substrate in a matrix form.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic cross-sectional view of a LCD device according to an embodiment of the present invention;

FIG. 2 illustrates a schematic plan view of first and second electrodes structure in the LCD device of FIG. 1;

FIG. 3 illustrates a schematic enlarged plan view of a unit pixel of the LCD device of FIG. 1; and

FIG. 4 illustrates a cross-sectional view along line I-I′ of FIG. 3.

### DETAILED DESCRIPTION OF THE INVENTION

Korean Patent Application No. 10-2007-0035632, filed on Apr. 11, 2007, in the Korean Intellectual Property Office, and entitled: “Liquid Crystal Display Device,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

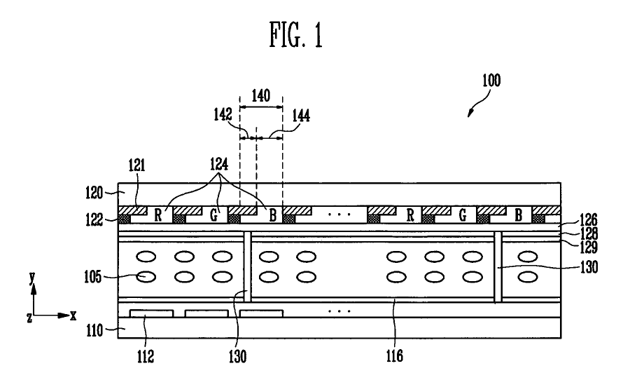

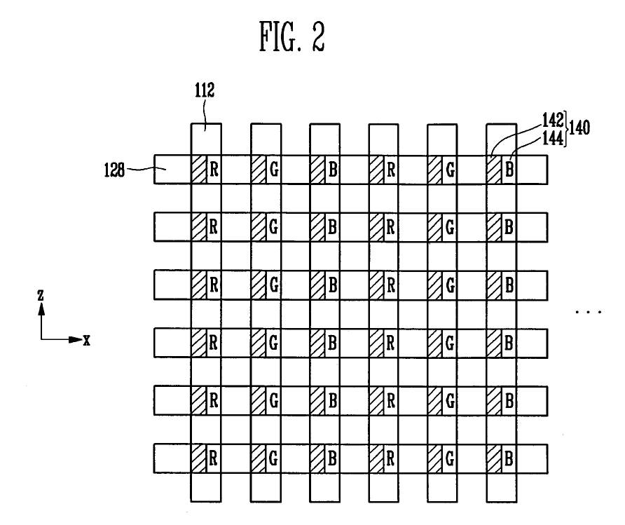

Hereinafter, an exemplary embodiment of a LCD device according to the present invention will be described in more detail below with reference to FIGS. 1-2.

Referring to FIG. 1, a LCD device 100, e.g., a passive-matrix operated transflective type LCD device, may include first and second substrates 110 and 120 facing one another to form an inner space therebetween for liquid crystals 105, first and second alignment layers 116 and 129 on inner surfaces of the first and second substrates 110 and 120, respectively, a plurality of color filters 124 between the first and second substrates 110 and 120, and a plurality of patterned spacers 130 positioned vertically between the first and second substrates 110 and 120 to maintain a uniform cell gap therebetween. Rubbing of the first and second alignment layers 116 and 129 may determine an alignment angle of the liquid crystals 105. “Inner surfaces” refer hereinafter to surfaces of layers and/or elements facing the liquid crystals 105.

Additionally, as illustrated in FIG. 1, pluralities of first and second electrodes 112 and 128 may be patterned on inner surfaces of the first and second substrates 110 and 120, respectively. The second electrodes 128 may be on the second substrate 120 and orthogonal to the first electrodes 112, so intersection regions between the first and second electrodes 112 and 128 may define sub-pixel regions 140, as illustrated in FIG. 2. Each sub-pixel region 140 may be divided into a reflective region 142 and a transmission region 144, and may include a color filter 124, e.g., red (R), green (G), and/or blue (B) filter, as further illustrated in FIG. 1. The sub-pixel regions 140 may have any suitable shape, e.g., rectangular.

More specifically, the reflective region 142 and the transmission region 144a may be defined by a reflective film 121. In particular, the reflective film 121 may be formed of a reflective material, e.g., an aluminum thin film, on an inner surface of the second substrate 120. The reflective film 121 may have a predetermined pattern, so a portion thereof may be positioned in each sub-pixel region 140. For example, the reflective film 121 may include a plurality of discrete reflective portions having openings, i.e., spaces, therebetween, so each reflective portion may be positioned in a respective sub-pixel region 140. The reflective portions of the reflective film 121 may extend along upper surfaces of the sub-pixel regions 140, i.e., a surface adjacent to the upper substrate 120, and in parallel thereto. Accordingly, an outer surface, i.e., a surface opposite the inner surface, of the reflective film 121 in the reflective region 142 may be exposed to the outside through the second substrate 120.

At least one reflective portion of the reflective film 121 and an opening adjacent thereto may correspond to each sub-pixel region 140. Accordingly, each sub-pixel region 140 may include at least one portion of the reflective film 121 and an opening. The reflective region 142 may correspond to a portion of the sub-pixel region 140 including a reflective portion of the reflective film 121, and the transmission region 144 may correspond to a portion of the sub-pixel region 140 including the opening, i.e., a portion of the sub-pixel region 140 including no reflective film 121. Formation of the sub-pixel regions 140 to include both reflective and transmission regions may facilitate use of both external light, i.e., light incident from the outside through the reflective regions 142 of the sub-pixel regions 140, and a backlight light source through the transmission regions 144. For example, the LCD device 100 may be a transflective type LCD device.

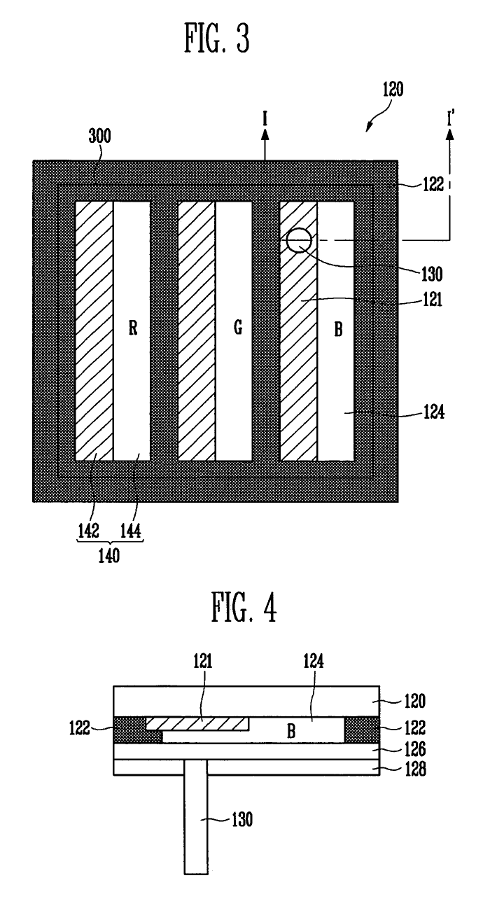

The color filters 124 of the LCD device 100 may be formed on an inner surface of the second substrate 120, and may be positioned in the sub-pixel regions 140. In particular, the color filters 124 may be configured to overlap both the reflective and transmission regions 142 and 144 of the sub-pixels 140. More specifically, a first portion of the color filter 124 may be on an inner surface of the reflective film 121, i.e., between the reflective film 121 and the liquid crystals 105, as illustrated in FIG. 1. A second portion of the color filter 124 may be in the transmission region 144. Each sub-pixel region 140 may include a red (R), a green (G), or a blue (B) color filter, as further illustrated in FIG. 1, so three sub-pixels implementing R, G, and B colors may form a unit pixel 300, as illustrated in FIG. 3. The LCD device 100 may include a plurality of pixels 300.

The color filters 124 may have irregular shapes, as illustrated in FIG. 4. More specifically, the color filters 124 may have a bent shape. For example, as illustrated in FIG. 4, the first and second portions of the color filters 124 may have different heights along the y-axis because of the reflection film 121, so a cross-section of the color filters 124 along a vertical plane, i.e., xy-plane, may have an “L” shape. The reflective portion of the reflective film 121 in each sub-pixel region 140 may be positioned to adjust heights of the first and second portions of the color filters 124, so an outer surface of the reflective film 121 may be aligned, i.e., level, with respect to an outer surface of the second portion of the color filter 124.

The patterned spacers 130 of the LCD device 100 may be formed to have constant intervals therebetween, and may be positioned to overlap with portions of the reflective film 121. In particular, the patterned spacers 130 may be positioned on the first substrate 110, and may extend vertically along the y-axis toward the second substrate 120. The patterned spacers 130 may be in contact with a planarization layer 126 and/or with the second electrodes 128, and may be positioned to overlap the reflective film 121 in the reflective region 142 of a corresponding sub-pixel region 140. For example, each patterned spacer 130 may have a narrower diameter than a width of reflective portion 142 along the x-axis, so a portion of the reflective film 121 in a corresponding sub-pixel region 140 may entirely overlap the patterned spacer 130. The patterned spacers 130 may overlap with either of the R, G, and/or B color filters 124 in the reflective regions 142 of corresponding sub-pixel regions 140. For example, the patterned spacers 130 may be configured to entirely overlap with the reflective regions 142 of sub-pixel regions 140 emitting either G or B lights.

The patterned spacers 130 may have a longitudinal structure, e.g., column-shaped spacer, and may be formed of a photo-spacer material. Further, the patterned spacers 130 may have, e.g., a circular, an oval, a square, and so forth, cross-sectional area in the horizontal plane, i.e., a plane parallel to a surface supporting the first substrate 110. The diameter of the patterned spacer 130 may be, e.g., about 17μm.

The LCD device 100 may also include a black matrix 122, i.e., an image non-display region for preventing leakage of light between adjacent sub-pixel regions 140. The black matrix 122 may be formed on an inner surface of the second substrate 120 between adjacent color filters 124, and may have a matrix structure. The black matrix 122 may separate the plurality of sub-pixel regions 140, as illustrated in FIG. 3, in order to prevent optical interference between colors of adjacent sub-pixel regions 140. For example, the black matrix 122 may completely surround each sub pixel region 140, as illustrated in FIG. 3. A portion of the black matrix may overlap with a portion of the reflective layer 121, as illustrated in FIG. 1.

The second electrodes 128 and the second alignment layer 129 may be formed sequentially on inner surfaces of the color filters 124 and the black matrix 122. Reference voltage for driving the LCD device 100 may be applied between the first and second substrates 110 and 120 through the first and second electrodes 112 and 128 to adjust the first and second alignment layers 116 and 129. First and second planarization layers 114 and 126 may be formed on the inner surfaces of the first and second substrates 110 and 120, respectively, as illustrated in FIG. 1.

Arranging the sub-pixel regions 140 to have reflective and transmissive regions, and positioning the patterned spacers 130 to overlap the reflective regions may be advantageous in substantially minimizing or preventing light leakage between adjacent sub-pixel regions 140 during alignment of the first and second alignment layers 116 and 129. For example, even when the alignment layer 129 is rubbed, positioning of the pattern spacers 130 outside the transmission region 144 may overcome the light leakage phenomenon and may provide improved transmittance through the transmission region 144 of the sub-pixel regions 140. More specifically, positioning of the patterned spacers 130 outside the transmission regions 144, i.e., overlapping with the reflective regions 142, may eliminate overlap between the patterned spacers 130 and the transmission regions 144, thereby improving light transmissivity and display quality. Further, the patterned spacers 130 may maintain a uniform cell gap between the first and second substrates 110 and 120, thereby eliminating light leakage and staining phenomenon.

The LCD device, e.g., a transflective type of the passive matrix scheme, according to embodiments of the present invention may be advantageous in providing patterned spacers that may be integrally formed at constant intervals, and may correspond to the reflective regions of the green or blue sub-pixel regions. Accordingly, light leakage that may be caused due to use of ball spacers or due to rubbing of the alignment layers may be prevented or substantially minimized. Also, the LCD device according to embodiments of the present invention may surprisingly improve contrast ratio as compared to, e.g., an LCD device of the passive matrix scheme including ball spacers.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display (LCD) device, comprising:
a first substrate having a plurality of first electrodes;
a second substrate facing the first substrate and having a plurality of second electrodes, the second electrodes being perpendicular to the first electrodes to define sub-pixels at intersection regions between the first and second electrodes;
a reflective film between the first and second substrates, the reflective film including a plurality of reflective portions, each reflective portion being positioned in a respective sub-pixel to define a reflective region and a transmission region in the respective sub-pixel;
a plurality of color filters between the first and second substrates, each color filter being in a respective sub-pixel and overlapping the reflective region and the transmission region of the respective sub-pixel;
a black matrix between the color filters;
a planarization layer between the first and second substrates;
a plurality of patterned spacers in respective unit pixels between the first and second substrates, each patterned spacer overlapping the reflective portion of the reflective film in the respective unit pixel; and
liquid crystals between the first and second substrates.

2. The LCD device as claimed in claim 1, further comprising first and second alignment layers on inner surfaces of the first and second substrates, respectively.

3. The LCD device as claimed in claim 1, wherein the color filters include red, green, and blue color filters.

4. The LCD device as claimed in claim 3, wherein three sub-pixels including red, green, and blue color filters define a single unit pixel.

5. The LCD device as claimed in claim 3, wherein the patterned spacers are in sub-pixels including green color filters and/or in sub-pixels including blue color filters.

6. The LCD device as claimed in claim 1, wherein the patterned spacers are on the planarization layer, the planarization layer being between the patterned spacers and the color filters.

7. The LCD device as claimed in claim 1, wherein the patterned spacers have a column shape.

8. The LCD device as claimed in claim 1, wherein each of the patterned spacers entirely overlaps the reflective portions of the reflective film in the respective unit pixel.

9. The LCD device as claimed in claim 8, wherein a diameter of the patterned spacer is narrower than the reflective portion of the reflective film in the respective unit pixel.

10. The LCD device as claimed in claim 1, wherein a reflective portion in each sub-pixel is on an upper surface of the sub-pixel, the upper surface being adjacent to the second substrate.

11. The LCD device as claimed in claim 10, wherein the color filters have a bent vertical cross-section.

12. The LCD device as claimed in claim 1, wherein the LCD device is a transflective type LCD device of a passive matrix scheme.

13. The LCD device as claimed in claim 1, wherein the black matrix is on the second substrate in a matrix form.
